(19) United States
(12) Patent Application Publication
(10) Pub. No.: US 2008/0209335 A1
(43) Pub. Date: Aug. 28, 2008

(54) CUSTOMIZABLE KIOSK SOFTWARE

(76) Inventors: Robert T. Walsh, Lawrenceville, GA (US); Michael J. Monk, Cumming, GA (US)

Correspondence Address: POWELL GOLDSTEIN LLP, ONE ATLANTIC CENTER FOURTEENTH FLOOR, 1201 WEST PEACHTREE STREET NW, ATLANTA, GA, 30309-3488, US

(21) Appl. No.: 11/680,175

(22) Filed: Feb. 28, 2007

(51) Int. Cl. G06F 3/01

(52) U.S. Cl. 715/744

(57) ABSTRACT

A user-interactive device (300) includes a user input device (301, 302, 303, 304) to allow a user to enter information, a display device (301) to display information to a user, a memory (320), the memory containing (320A) a logic program, a browser program, and a preferences file, a processor (321) functionally connected to the user input device, the display device, and the memory, and configured to execute the at least one logic program and the browser program, to intercept a request from the browser program for a home page, to inspect a preferences file for browser preference information, to generate a home page for the browser based upon the browser preference information, and to cause the browser program to display the generated home page to the user. User preferences may be stored locally or obtained from an Integrated Library System (315) via a network connection (310).

### CROSS-REFERENCE TO RELATED APPLICATIONS

This application claims priority to, and the benefit of, U.S. Provisional Patent Application Ser. No. 60/777,294 filed Feb. 28, 2006, entitled “CUSTOMIZABLE KIOSK SOFTWARE”, which is incorporated herein by reference in its entirety.

### BACKGROUND

User self-service kiosks are well-known today, and are frequently used for self-checkout in grocery stores, to locate a company in a building, or to find what floor in a building that a particular person is on, etc.

The problem with such kiosks is the difficulty in customization of the user interface or display. The interface and display are fixed by the programming and it is generally onerous, if not extremely difficult, to change the programming to accommodate a new look, feature, or function.

Likewise, it is generally onerous, if not extremely difficult, to change the programming to accommodate a new client wanting a kiosk.

### SUMMARY OF THE INVENTION

A method for operating a user-interaction device includes initiating a browser program, intercepting a request from the browser program for a home page, inspecting a preferences file for browser preference information, generating a home page for the browser based upon the browser preference information, providing the generated home page to the browser, and displaying the generated home page to the user via the browser.

A user-interactive device includes a user input device to allow a user to enter information, a display device to display information to a user, a memory, the memory containing a logic program, a browser program, and a preferences file, a processor functionally connected to the user input device, the display device, and the memory, and configured to execute the at least one logic program and the browser program, to intercept a request from the browser program for a home page, to inspect a preferences file for browser preference information, to generate a home page for the browser based upon the browser preference information, and to cause the browser program to display the generated home page to the user.

### BRIEF DESCRIPTION OF THE DRAWING

FIGS. 1A and 1B illustrate the operation through a background application and a browser program.

FIGS. 2A through 2H illustrate some of the commands, processes and functions.

FIG. 3 illustrates an exemplary environment and shows an exemplary library kiosk.

### DESCRIPTION OF THE INVENTION

A background or underlying application (“Bapp”) controls the operation and appearance of the kiosk. The Bapp is used with a web browser, such as Internet Explorer or Netscape Browser and monitors for (intercepts) link requests from the browser. Three types of link requests are used and monitored, although there could be more types, if desired. Preferably, but not necessarily, all requested links are internal, that is, they are provided by the system, and an external (e.g., Internet) connected is not required.

If the requested link is a standard URL, for example, http://www.browserpage.com, then the Bapp acts as a web server and provides the “web” page (HTML) information to the browser, which the browser then operates on. Although the information is provided as a “web” page, the web page may be stored locally in the server, so that Internet access is not required. The Bapp preferably has, or has access to, a plurality of preprogrammed “web” pages. It should be noted that spaces have been inserted into the exemplary hyperlinks herein so as to avoid accidental linking to an actual present or future web site; such spaces would not normally be present in a hyperlink.

This information may be, for example, the startup (home) page for the kiosk. For example, “Welcome To The Duluth Library”, “Welcome To Duluth Central High School”, “Welcome To The Greater Duluth Shopping Mall”, etc.

As another example, the startup page may immediately provide the user with options. For example, “Scan Customer Identification Card Now”, “Enter Customer Identification Number Now”, “Enter Name Of Person Now”, “Enter Name Of Book Now”, “Enter Name Of Author Now”, etc.

If the requested link is to obtain data or other information from a local, non-web page server or host, for example, http://localhost.data, then the Bapp requests that data from the local host, such as customer account data from a library customer account server. The returned information may then be used by the Bapp to generate a web page, which is then sent to the browser, and/or the returned information may be used to control the next page that is sent to the browser for display or to control the next page that the browser displays.

If the requested link is to launch an application which provides some desired functionality, for example, launch://c:/cardscanner.exe, then the Bapp calls and executes the local application. The Bapp may provide certain parameters from the browser or the local host to the local application. The Bapp may, if desired, hide the browser window, partially or entirely, while the local application is running. Once the local application has provided the result or functionality then the Bapp may terminate the local program window, if any, and/or return the browser window to the foreground. The Bapp may use any results from the local application to generate and provide a web page to the browser, access the local host for additional information, and/or determine the next web page to be displayed by the browser.

Consider now an example of operation of the present invention in the context of a self-service kiosk in a library setting. Upon startup, the Bapp initiates the browser, which may call for a home page. The Bapp intercepts the request, if any, accesses a preferences file, inspects the state of the several variables in the file, generates a home web page based upon those variables, and provides the home page to the browser, which then displays the home page to the user. The home page may have, for example, the name of the library and touch screen buttons offering the user various options. The options may be a menu of any actions that the user is allowed to take at that point, for example, scan in user ID card, punch in user ID name and/or password, check account balance, browse through publications available, checked out, or requested, check out a selected publication, make a payment toward an account to pay outstanding fees or generate a credit balance, etc. Or, there may be no options at that point, and the user is simply instructed to take an action, such as to scan in the user's ID card, enter the user's ID name and/or password, etc. The Bapp also initiates other local applications responsive to external devices, such as a scanner, a card reader, or touch screen response program.

When the user scans his/her ID card using the local scanner (or keys in a username and password) the local application provides this data to the Bapp. The Bapp then provides that information to the local host along with a request for library patron account data. The local host returns some or all of the account data and, based upon certain information in the account data, the Bapp then determines the next page to be provided to the browser. For example, if the patron has an outstanding fee balance (or one exceeding a predetermined amount or a predetermined time) then a “service denied until outstanding fees paid” webpage may sent by the Bapp to the browser. The Bapp may use a previously stored web page, or may use a previously stored web page and insert the outstanding balance. As another example, if the patron is a child, the Bapp may send to the Browser a previously stored children's web page, or may use a previously stored children's web page and insert the child's name. As another example, if the patron is an adult, the Bapp may send to the Browser a previously stored adult web page, or may use a previously stored adult web page and insert the patron's name. As another example, if the patron has previously specified certain preferences for his/her startup page, then the Bapp may send to the Browser a previously stored customized web page. For example, an elementary school teacher may want to set the preferences so that the startup page is a children's books page.

Assume, for example, that the user is an adult with no specified preferences and no outstanding balance, in which case a standard adult web page might be returned from the Bapp to the browser for display to the user. The standard web page might have, for example, buttons to check out a book, to pay part or all of an outstanding fee balance, to pay into a credit balance, to check the fee or credit balance, cancel a transaction, exit, etc.

For example, the user might then press the button to check the credit balance. This would cause the browser to request a particular link, e.g., http://localhost.creditbalance. The Bapp would note that the link is for the credit balance and pass the user ID information to the local host along with an instruction or request to provide the credit balance. Once the local host returned that information, the Bapp would insert that information into a previously stored web page and then provide that web page to the browser for display to the user. That previously stored web page would also have the options the user could then take at that point. The Bapp might return different previously stored web pages depending upon whether the user had an account balance, no account balance, or an account credit.

As another example, the user might then press the “check out a book” button on the touch screen. The Bapp would note that the link is to check out a book and the Bapp might return a web page to the browser which instructed the user to scan the book, key in an identification number for the book, and/or provide other options available to the user. If the user scans a book, the scanner provides this information to the Bapp, which provides the information to the local host with an instruction to update the user's account. The local host updates the account data to show that the user has checked out that book on that date, and then returns the name, author, due date, etc., for that book. The Bapp then inserts this information into a web page and returns that web page to the browser.

The user can then select the “check out a book” button again, or just scan in another book.

Finally, if the user selects, for example, “Done” or “Finished”, on the touch screen, then the browser sends a request for a link to, for example, http://localhost.finished. The Bapp inspects the link, advises the local host that the user is done, and may then return a “Thank You” web page to the browser for presentation and/or, after a specified amount of time, return the startup web page to the browser.

Either the touch screen or an external device may be used to perform certain steps or even to initiate action. For example, the user may begin pressing the “scan ID card” button on the screen, or may begin simply by scanning his/her ID card, or by scanning in a book code.

Thus, rather than writing a single program, which would be difficult or impossible to customize for each application, the present invention uses a standard web browser program and a background application. The background application inspects the link requested by the browser and either supplies a previously stored web page in response to the request or, if appropriate, uses the request to determine what task to undertake, such as requesting data from a local host, or executing an application, and, based upon the results of the task, returns a web page to the browser.

Therefore, if a screen display needs to be changed to accommodate a new feature or function or client, a new web page is written for the new item, and the Bapp then calls that new web page. Further, standard or “form” web pages may be created and used which have blanks for insertion of desired information, and the Bapp calls the servers and/or programs necessary to obtain that information, then inserts that information into the blanks, optionally stores that new web page, and then provides that new web page to the browser for action and display.

For example, several local libraries in the same county library system could use the same software and executable code, but each would have a different set of startup preferences which would, include, for example, links to, or information regarding, the name, address, telephone number, and/or hours of operation of the particular library, and/or a picture of the library building, etc. Likewise, several branches of a company could use the same software and executable code, but each would have a different set of startup preferences which would, include, for example, links to, or information regarding, the name, address, telephone number, and/or hours of operation of the particular branch, the persons working at that branch, the services or products available at that branch, etc.

Thus, an administrator can generate and/or select an appearance and/or workflow control without having to modify the executable code. “Workflow” includes, but is not limited to, the screens or other displays which are presented to the user, the order of presentation, the options presented on a screen or display, the links between screens, displays, and/or options, the user-input devices which are activated or available for use, the type of output devices which are activated or available for use, such as a printer, or a CD or DVD burner, etc.

In addition to a built-in library of functions to perform such things as ‘validate user’, ‘check out materials’, ‘query fines’, etc, an administrator can dynamically create new preferences which are inherited into the system and made accessible at the presentation and workflow layer. Thus an administrator can define an attribute like ‘long reset page interval’ and define the parameter in a preference file. Another preference like ‘short reset page interval’ provides a different system parameter. Parameters can be accessed from anywhere in the system and used as a global variable to control behavior.

Because the complete user interface is rendered in a protected html rendering engine, the administrator can also define other html-oriented appearances which, for example, may include sounds, movies, and other animation, as well as international language characters, emphasis, and text attributes. The administrator may also provide and select graphics which are then mixed to create the desired effect. The interface can provide a mix of graphics, sounds, and animation to teach the user how to interact with the system.

Based on attributes in the library automation server, the system can change the workflow dynamically. For example, a child user (based on age or patron type) might see a different page layout and experience a different workflow than that of an adult patron. A user that owes a fine may experience a different set of pages than a user in good standing. As the system responds to conditions provided from the external library system patron database coupled with the patron's status, each user may see a different set of screens, words, or illustrations and each user may follow a different workflow. Of course, the external library system patron database, or selected portions thereof, could be copied into the device so as to provide for faster access or limited access, such as when the library database server was busy or temporarily out of service or not accessible, or even so as to provide for a faster initial response while the library database server is being queried.

The system can therefore be easily customized in appearance and workflow by parameter changes, both those statically defined in the system and those defined by the owning administrator.

The power of the system can be extended and enhanced as the administrator can add java script, images, or animation to the system to increase its flexibility or usefulness to the library or customers of the library. Because every community has unique needs, the power of customizing the appearance and workflow of the system cannot be underestimated. Thus, one real benefit is that the functionality and appearance of the system can be easily extended and/or modified without the need to request or write enhancements to the executable code.

The core executable code is an execution engine that hosts the rendering engine, controls access to the desktop, and provides a link to the automated library system. It also controls the kiosk hardware, preferably using a secure protocol and/or link, such as a private Ethernet LAN. Propriety protocols may also be used to provide additional security. Instructions are transmitted to the kiosk hardware to, for example, accept funds, print receipts, enable/disable item security, and other hardware-related tasks.

Another benefit is that cash reconciliation can be performed from a graphical user interface, cash can be added to the system, and running ‘meters’, such as electronic ledgers or spreadsheets, can log financial transactions. Thus an administrator can control cash escrow in the kiosk as well as reconcile payments and funds in the hardware from the screen. This allows a user to quickly and easily reconcile fine collections from the kiosk application. The file system that stores financial transaction data, such as the running meters, preferably contains encrypted data and is password protected to protect the data against tampering. Historically, this information would be downloaded from a hardware device and manipulated elsewhere using spreadsheets.

Updating the core application can therefore be performed without affecting any interface or workflow behavior. New functionality can be readily implemented by selecting or activating a new or different preference. The administrator can quickly modify the system to adapt to a changing environment or adopt a new behavior in the workflow of the customized html script.

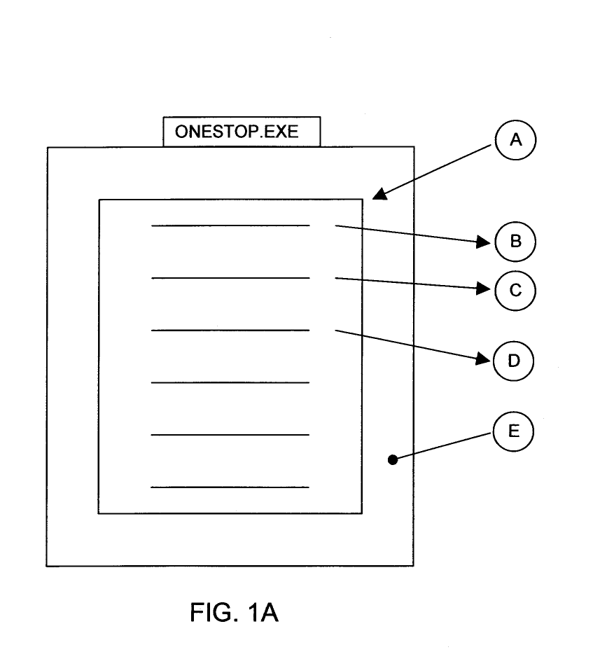

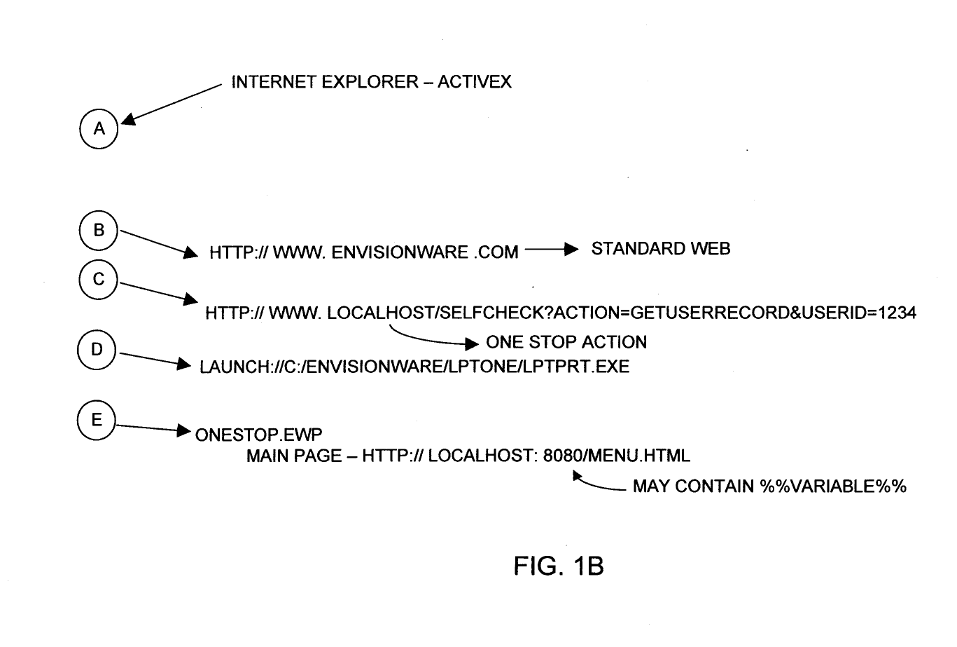

FIGS. 1A and 1B illustrate the operation through a Bapp named “onestop.exe”.

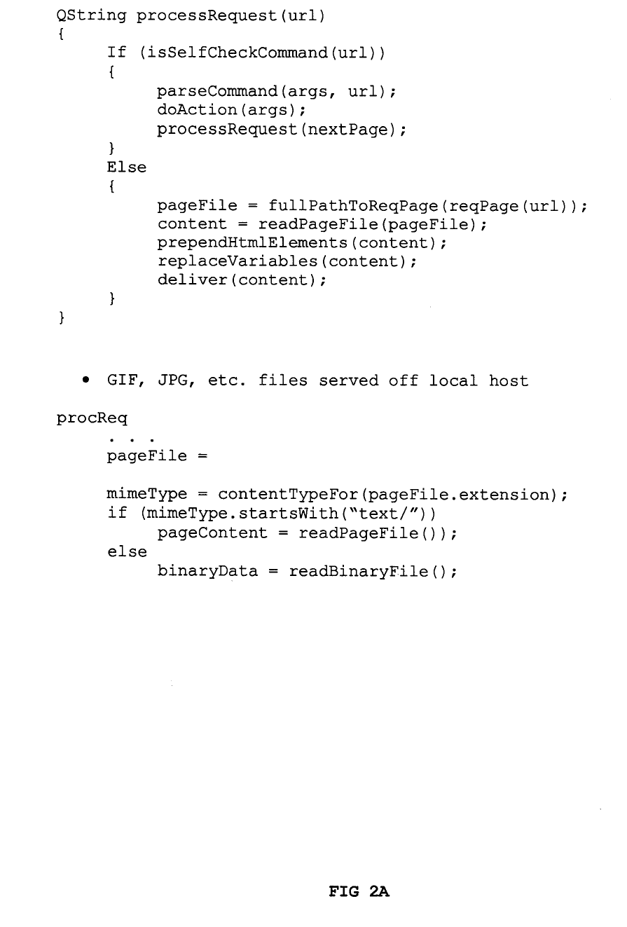

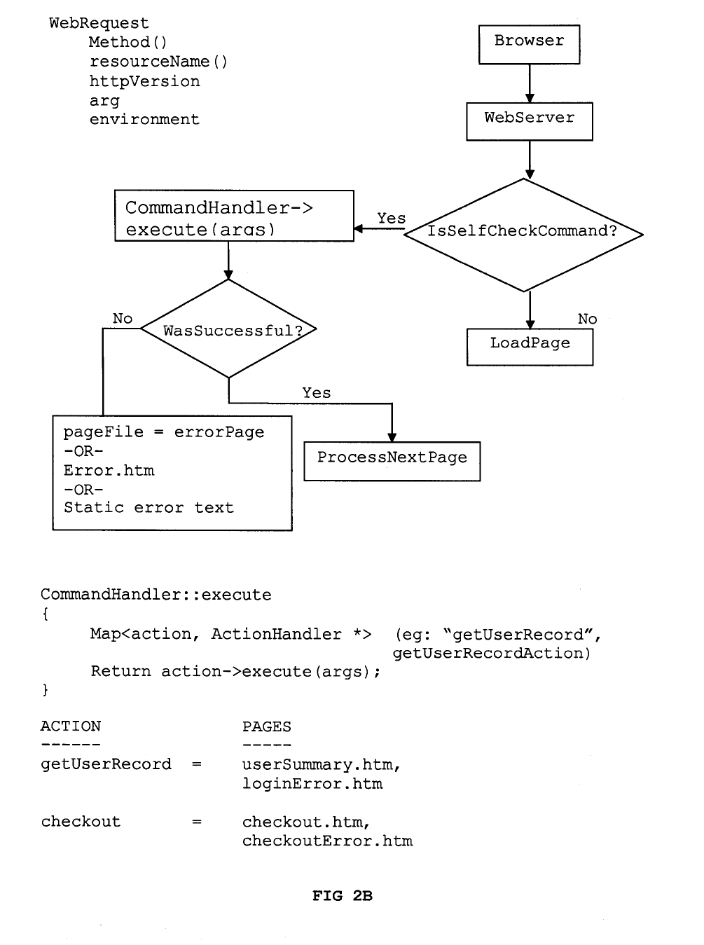

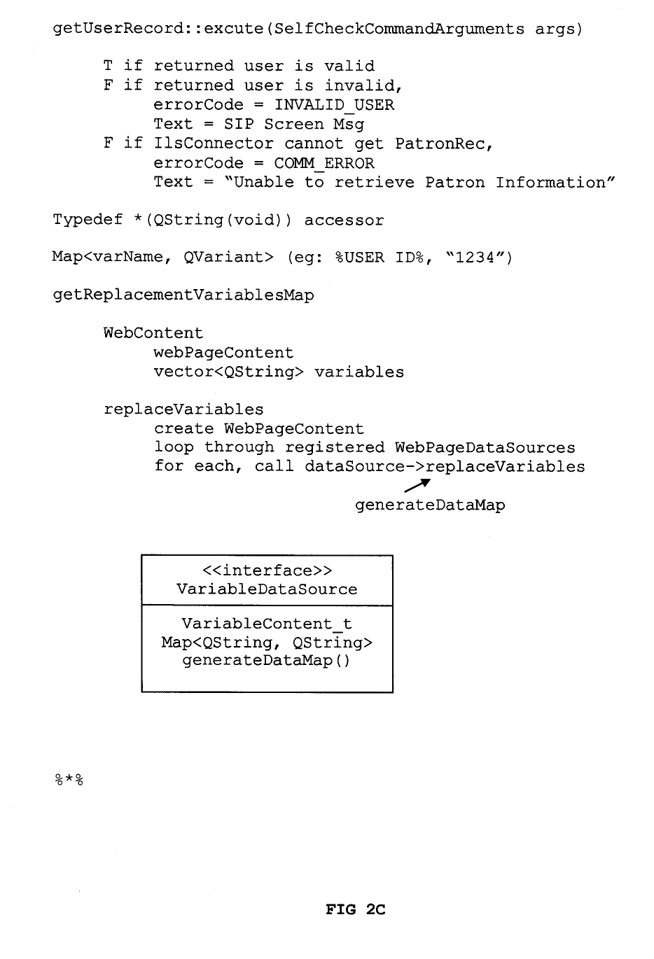

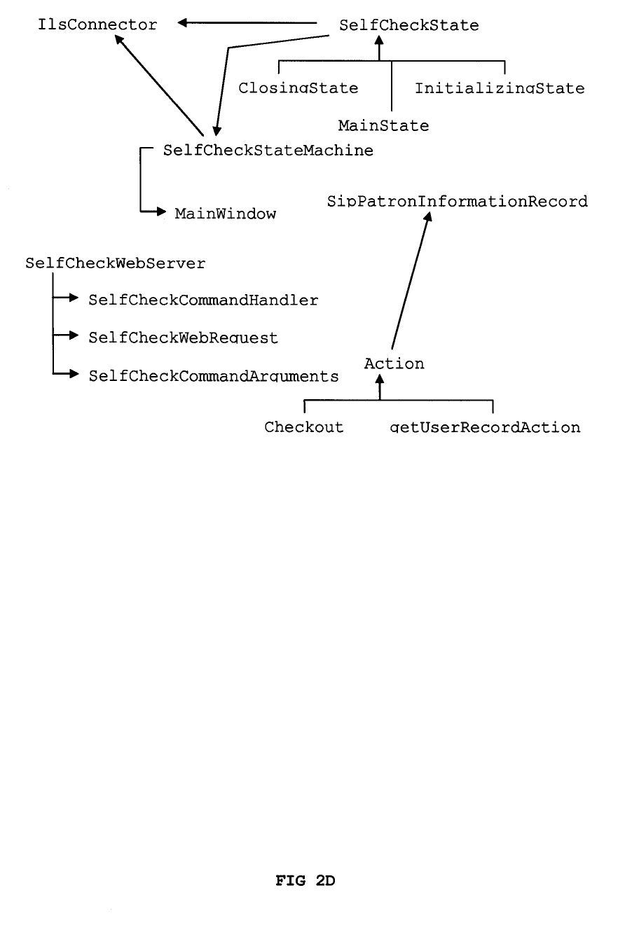

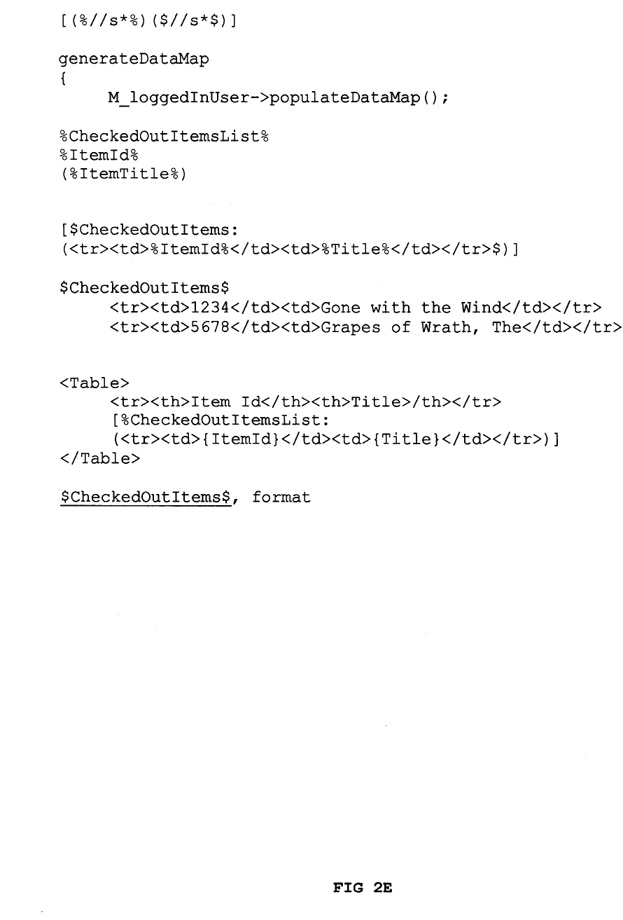

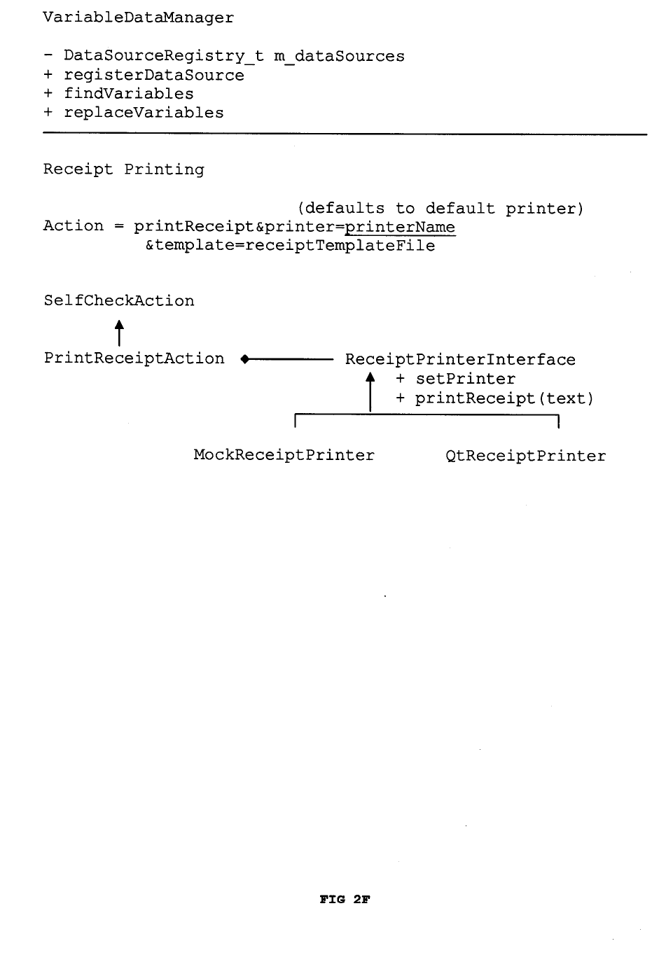

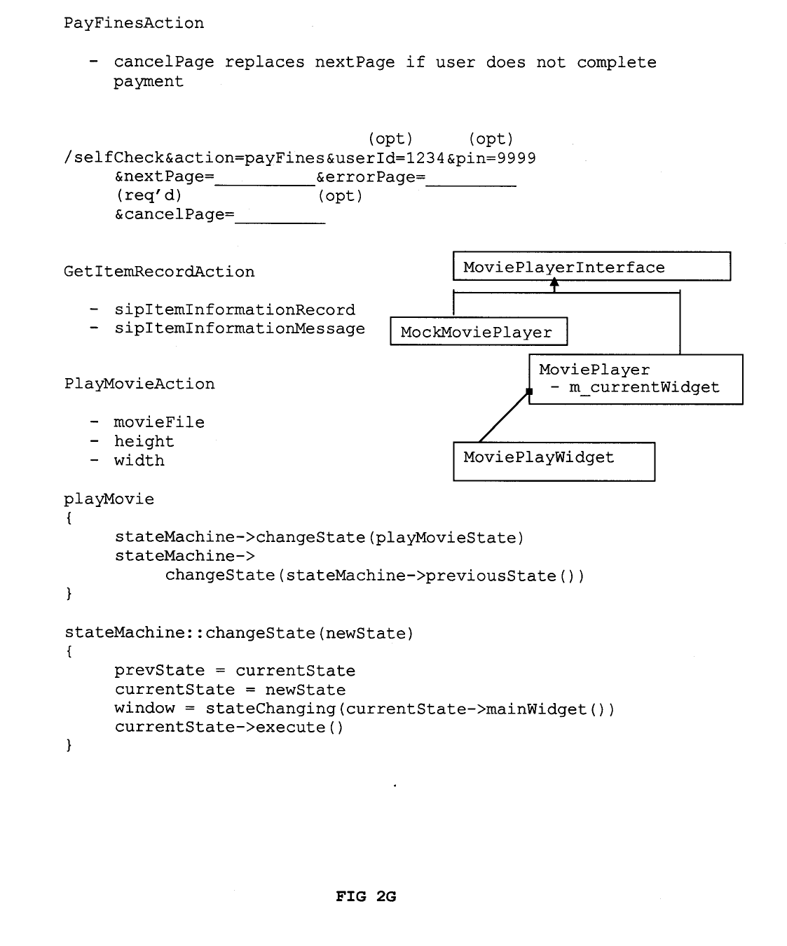

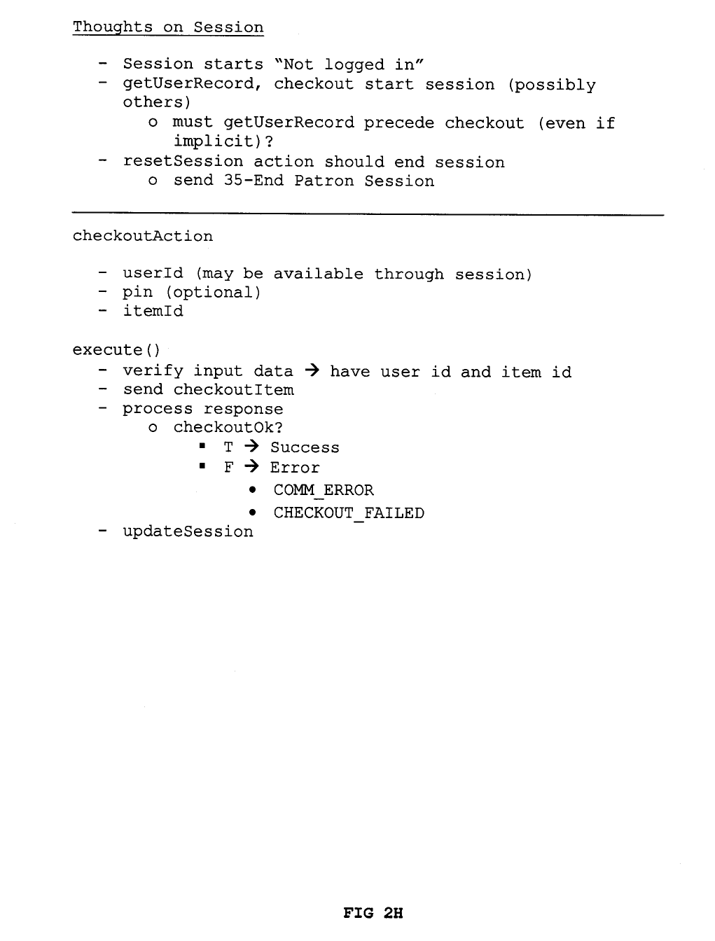

FIGS. 2A through 2H illustrate some of the commands, processes and functions.

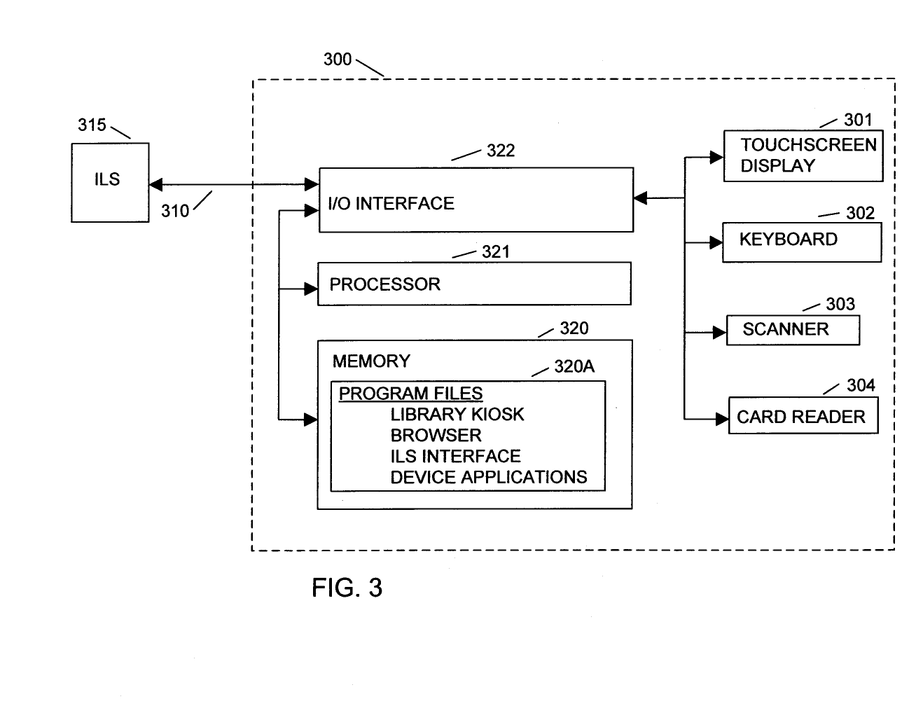

FIG. 3 illustrates an exemplary environment for implementation of the present invention and shows a library kiosk 300 having a display 301 for a user, user input devices (touchscreen 301, keyboard 302, card reader 304, scanner 303, etc.), and a connection 310 to an Integrated Library System (ILS) 315. The kiosk has memory 320 (volatile and non-volatile), a processor 321, input/output interfaces 322, and a program cache 320A in memory 320 including, for example, the LibraryKiosk program, a browser program, an ILS interface program, and device specific application programs for the display and the user input devices.

Consider now the program details of an exemplary application of the present invention, a library kiosk. This represents the future of self service in public libraries. It incorporates in a single kiosk the abilities to check in and check out library materials, view and pay library fines, release print jobs, reserve library materials, and manage funds placed on deposit with the library. Library materials is used in its broadest sense and encompasses any media including, but not limited to, books, magazines, periodicals, tapes, CDs, DVDs, etc.

A Self-check Module (SCM) manages the self-service circulation of library materials. It uses an interface composed entirely of HTML pages interacting with a self-contained web server that understands a number of specialized commands (“actions”). In addition, real-time information is made available to the HTML pages through special variables that are embedded in the pages and replaced by the Local web server when the pages are delivered.

The page rendering engine used by the kiosk is the Internet Explorer ActiveX control. As a result, the rendering engine theoretically can handle any page that can be rendered in Internet Explorer. This means the pages may contain Flash, JavaScript (or ECMAScript as it is now formally known), and other rich multimedia content.

By combining HTML, JavaScript, the Specified variables, and the Specified actions, the user's self-service experience may be customized in any number of ways. The information presented on each page or even the workflow governing the page transitions may be changed to suit the needs and desires of the library customer. The program can be distributed with at least one (and possibly several) “canned” configurations that, with minimal modifications, are suitable for use in a wide variety of library environments. Plans are being considered to offer more extensive customizations as an added service, and libraries with qualified web design staff may choose to design their own interfaces.

Configuring LibraryKiosk

The configuration is managed through the LibraryKiosk.ewp file found in the LibraryKiosk\config directory. The file preferably is text in XML format. The following exemplary table lists the available options in this file.

TABLE I

| Entry Name¹ | Description | Recommended Value |
|---|---|---|
| ILS Server Address | The TCP/IP address of | Site Specific |
| | FQDN of the ILS SIP | |
| | Server | |
| ILS Server Port | The TCP/IP port on which | Site Specific |
| | the ILS Server accepts SIP | |
| | connections² | |
| ILS Checksum Enabled | Flag indicating whether the | Site Specific |
| | ILS Server expects (and | 1 - On |
| | may require) SIP | 0 = Off |
| | checksums (AY/AZ fields) | |
| ILS Keep Alive Interval | Value indicating how often | TBD |
| | LibraryKiosk should send | Value is in milliseconds. |
| | a SIP status request to the | A lower value makes |
| | ILS Server. It is intended | LibraryKiosk more responsive in |
| | to give LibraryKiosk a way | recognizing lost connections but |
| | to detennine when the | increases SIP traffic. |
| | connection has been lost. | |
| ILS Require User Pin | Value indicating whether | Site Specific |
| | the ILS Server requires a | 1 = On |
| | user to enter a PIN to | 0 = Off |
| | validate | |
| ILS LibraryKiosk Location | The location text | Site Specific |
| | associated with this | This value is sent with checkin |
| | Library Kiosk | requests to tell the ILS where the |
| | | media was returned. |
| Web Server Document | The directory that will be | LibraryKiosk_program_directory/ |
| Root | considered the web server | html |
| | root for serving pages | |
| Web Server Port | The port on which | 8080 |
| | LibraryKiosk's web server | |
| | will listen for connections | |
| Default Language Code | The language id for the | en |
| | default language. This | |
| | value is appended to the | |
| | Web Server Document | |
| | Root to tell LibraryKiosk | |
| | where to find the requested | |
| | page. | |
| eCommerce Client Path | The path to the Library | Library_Fines_Pay_Client_Directory\ |
| | Fines Pay Client | ewFinesPay.exe |
| eCommerce Server | The TCP/IP address or | Site Specific |
| Address | FQDN of the eCommerce | |
| | Server | |
| Ecommerce Server Port | The TCP/IP port on which | 1962 |
| | the eCommerce Server | |
| | listens for connections | |
| Use Kiosk Hardware | Flag indicating whether | 1 |
| | LibraryKiosk should | 1 = On = LibraryKiosk is running |
| | attempt to communicate | on Kiosk hardware |
| | with the Kiosk Control | 0 = Off = LibraryKiosk is software |
| | Board | only |
| Kiosk Hardware | How often LibraryKiosk | 3000 |
| Monitoring Interval | should attempt to | Value is in milliseconds |
| | communicate with the | |
| | Kiosk Control Board | |
| Kiosk Hardware VIM port | The TCP/IP port on which | 1071 |
| | LibraryKiosk should listen | |
| | for vending requests from | |
| | other applications | |
| Main Page | The page the LibraryKiosk | http:// localhost: 8080/menu.html |
| | kiosk should load at startup | |
| Run Full Screen | Flag indicating whether | 1 |
| | LibraryKiosk should run in | 1 = On |
| | full screen mode (no title | 0 = Off |
| | bar, no task bar) | |
| Run On Private Desktop | Flag indicating whether | 1 |
| | LibraryKiosk should create | 1 = On |
| | its own Windows desktop | 0 = Off |
| Require Password To Exit³ | Flag indicating whether | 1⁴ |
| | LibraryKiosk should | 1 = On |
| | require a password to close | 0 = Off |

Notes:

The Entry Names in LibraryKiosk.ewp are preferably case sensitive.

Reserved

Reserved

In environments where the program runs on a private desktop without a standard keyboard accessible to the end-user, this value could be set to 0 (off) since an end-user would have no way to close the program.

Starting and Stopping the Program

The LibraryKiosk program runs as an application. To start, simply double-click the LibraryKiosk application from Windows Explorer. The LibraryKiosk program looks for the configuration file in the configuration subdirectory. If it cannot find the configuration file it will assume default values for all entries. It should be noted, however, that many entries are site specific and may not be valid, and so the system may not operate properly or at all.

Several options exist for stopping the program depending on the mode in which it is running. If running as a normal Windows application (not full screen), simply click the close button in the upper right corner. Depending on the value of “Require Password To Exit”, the user may be prompted to enter a password. If it is running full screen, there is no title bar and, therefore, no close button. In this case, use the Alt-F4 key combination to close the application. Again, the user may be prompted for a password.

Actions

The LibraryKiosk program responds to special URLs by invoking actions. The general syntax for these actions is:

http://localhost/selfCheck?action=action_name&param_name=Param_value& . . . & nextPaqe=page_to_deliver_when_action_is_complete

It is possible to use HTTP form posting techniques to post the request to LibraryKiosk.

At this time, the action attribute and the nextPage attribute are provided. If either is omitted, LibraryKiosk will deliver the system error page. The system error page is error.htm located in the web server document root. All actions may override the system error page by specifying an alternate using the errorPage attribute as part of the URL.

In addition to the system error page, there is a built-in page (ILSUnavailable.htm) for times when an action requires the ILS and the connection to the ILS is not available. (It is possible also to use LibraryKiosk variables and JavaScript to disable links to actions that require the ILS when the ILS is not available.)

Action—getUserRecord

Description—retrieves a user's account record from the ILS (sends a SIP 63 message).

Attributes
userid (required)—the library card number for the user whose record is to be retrieved
pin (optional)—the user's pin. Whether it is required depends on the ILS configuration
feeOwedPage (optional)—if present and if the user owes a fee, processing is redirected to this page
pinEntryPage (optional)—if present and if ILS validation requires a pin and if the pin is not supplied, processing is redirected to this page

Action—getItemRecord

Description—retrieves an items' record from the ILS (sends a SIP 17 message)

Attributes
itemId (required)—the item's barcode number

Action—checkout

Description—requests that an item be checked out through the ILS (sends a SIP 11 message). If the SIP Checkout Response (12 message) indicates the checkout was successful processing continues with the nextPage attribute. If not, processing continues with the errorPage attribute (or the system error page).

Attributes
UserId (required, may come from cached session data)—the library card number for the user to whom the item is to be checked out. If getUserRecord has already been called (and resetsession has not been called), LibraryKiosk may use the UserId stored in the current session.
pin (optional, may come from cached session data)—the user's pin.
feeOwedPage (optional)—specifies the URL of the page to deliver if checking out the item requires a fee. This can be used to change the workflow dynamically for items that have a fee associated with checkout.
demo (optional, intended only for demonstrations where a live ILS is not practical)—if set to T, TRUE, Y, or YES (ignoring case), LibraryKiosk will not attempt to contact the ILS to checkout the item. Instead, it will simply pretend that the checkout occurred.
itemTitle (optional, used only with demo)—specifies the item's title if the checkout is done in demo mode, ignored otherwise.

itemDueDate (optional, used only with demo)—specifies the item's due date if the checkout is done in demo mode, ignored otherwise.

Action—renewItem

Description—requests that an item be renewed through the ILS (sends a SIP 29 message). If the SIP Checkout Response (30 message) indicates the renewal was successful, processing continues with the nextpage attribute. If not, processing continues with the errorpage attribute (or the system error page).

Attributes
userId (may come from cached session data)—the library card number for the user for whom the item is to be renewed. If getUserRecord has already been called (and resetsession has not been called), LibraryKiosk may use the UserId stored in the current session.
pin (optional, may come from cached session data)—the user's pin.
feeOwedPage (optional)—specifies the URL of the page to deliver if renewing the item requires a fee. This can be used to change the workflow dynamically for items that have a fee associated with renewal.
demo (optional, intended only for demonstrations where a live ILS is not practical)—if set to T, TRUE, Y, or YES (ignoring case), LibraryKiosk will not attempt to contact the ILS to renew the item. Instead, it will simply pretend that the renewal occurred.
itemTitle (optional, used only with demo)—specifies the item's title if the renewal is done in demo mode, ignored otherwise.
itemDueDate (optional, used only with demo)—specifies the item's due date if the renewal is done in demo mode, ignored otherwise.

Action—checkin

Description—requests that an item be checked in through the ILS (sends a SIP 09 message). If the SIP Checkin Response (10 message) indicates the checkin was successful processing continues with the nextpage attribute. If not, processing continues with the errorPage attribute (or the system error page).

Attributes
itemId (required)—the barcode number of the item to be checked in

Action—payFines

Description—launches the LibraryKiosk Fines Pay Client to allow the user to pay fines or fees owed to the library. The path to the Fines Pay Client is specified in the LibraryKiosk configuration.

Attributes
UserId (may come from cached session data)—the user's library card number.
pin (optional, may come from cached session data)—the user's pin.
cancelPage (optional)—will be delivered if the user cancels the fines payment action without making a payment.
feeAmount (optional)—causes the Fines Pay Client to collect the specified amount rather than retrieving the user's fee from the ILS. Without this attribute, the Fines Pay Client obtains the user's fine from the ILS. This attribute permits the Fines Pay Client to collect a fee related to a specific task (checking out a video, etc).

Action—playMovie

Description—plays a movie file in the kiosk window. This might be used to provide a help video to a user.

Attributes
movieFile—specifies the full path (relative to the hard drive root, not the web server document root) to the movie file. Movie files may be in any format supported by Windows Media Player.

Action—printCheckoutReceipt

Description—prints a checkout receipt for the user.

Attributes
template—specifies the full path (relative to the hard drive root, not the web server document root) to the template file that defines the receipt layout.
printer (optional)—specifies the printer name of the printer to which the printer should print. This name should match the printer name in the Windows Printers folder. If the printer is a shared network printer, the name includes the server name or some other appropriate identifier or routing for that printer. For example, the printer “HP LaserJet 4100” hosted by Printserver would be specified as printer=\\PrintServer\HP LaserJet 4100.

Action—changeLanguage

Description—changes the language code used to determine which pages will be delivered. For example, if the language code is “FR” and the Web Server Document Root is “C:\LibraryKiosk\html”, then pages will be delivered from “C:\LibraryKiosk\html\FR”. The language remains set until changed again or until a resetSession action is executed. The resetSession action returns the language to the default.

Attributes
languageCode (required)—specifies the language code that will be added to Web Server Document Root to determine the “effective” root for locating pages.

Action—resetSession

Description—resets the internal session by clearing the current user, checked out items, and language code

Attributes—none

LibraryKiosk Variables

The LibraryKiosk program supports a rich set of variable data that may be embedded in pages as they are delivered to the kiosk. Some variables are available only in certain contexts, while others are available at all times. Variables are identified using %%Variable_Name%% in the HTML page. Variables are case sensitive and are arranged in a hierarchical fashion using a dot notation.

When LibraryKiosk encounters a variable, it looks at the currently available data to find a match. If a match is found, the variable placeholder in-the HTML page is replaced with the value of the variable held in LibraryKiosk. If no match is found, the variable is removed from the HTML page and replaced with an empty string. Variables may be used to display dynamic or customized information, or they may be used by JavaScript code to make decisions and provide conditional logic.

Some variables represent lists instead of a single piece of information. For example, as the user checks out materials, the items are collected and made available through a list variable. List variables use a different syntax than regular variables, and this syntax allows the system administrator to define the format for each item in the list. An exemplary list variable syntax is shown below.

$$List_Variable_Name{format_for_each˜item˜in˜the˜list}$$.

Variables

Error
%%Error.Code%%—the error code associated with the last action
%%Error.Text%%—a textual description of the last error. For some actions, this value is the text from the SIP Screen Message (AF) field.

Session
%%Session.lsUserLoggedln%%—flag (Yes or No) indicating whether a user is currently logged in to a session. A successful getUserRecord action logs the user into a session. The user is logged out when the resetsession action executes.
%%Session.UserId%%—text representing the library card number of the user currently using the system. GetUserRecord may now register a user with the session without performing a login (in other words, without validating against the ILS)
%%Session.NumberOfItemsCheckedOut%%—number indicating how many items the user has checked out this session. This value is cleared when a resetSession action executes.

Date/Time
%%Date.Year%%—the current year
%%Date.Month%%—the current month (January=1)
%%Date.Day%%—the day of the month
%%Date.Text%%—a text representation of the current date. The format is “Sat May 20, 1995”
%%Date.IsoText%%—a text representation of the current date in ISO format (“YYYY-MM-DD”)
%%Date.LocalText%%—a text representation of the current date. The format depends on the system locale.
%%Date.MonthName%%—the name of the month (localized)
%%Date.ShortMonthName%%—the abbreviated month name (localized)
%%Date.DayName%%—the name for the current day (localized)
%%Date.ShortDayName%%—the abbreviated day name (localized)
%%Time.Hours%%—hours since midnight (24 hour format)
%%Time.Minutes%%—minutes past the hour
%%Time.Seconds%%—seconds past the minute
%%Time.Milliseconds%%—milliseconds past the second
%%Time.Text%%—a text representation of the current time. The format is “HH:MM:SS” using a 24 hour clock.
%%Time.IsoText%%—a text representation of the current time. The format is “HH:MM:SS” using a 24 hour clock.
%%Time.LocalText%%—a text representation of the current time. The format is dependent on the system locale.

ILS
%%Ils.IsConnected%%—flag (Yes or No) indicating whether LibraryKiosk has a valid connection to the ILS. This value cannot always be guaranteed, but a frequent keep alive (or lots of activity) make it reasonably reliable.
%%Ils.InstitutionId%%—text representing the ILS Institution Id exchanged in various SIP messages. This value is set from the initial handshake with the ILS.

User
%%User.ChargePrivilegesDenied%%—flag (Yes or No) representing the SIP field of the same name
%%User.RenewalPrivilegesDenied%%—flag (Yes or No) representing the SIP field of the same name
%%User.RecallPrivilegesDenied%%—flag (Yes or No) representing the SIP field of the same name
%%User.HoldPrivilegesDenied%%—flag (Yes or No) representing the SIP field of the same name
%%User.CardReportedLost%%—flag (Yes or No) representing the SIP field of the same name
%%User.TooManyItemsCharged%%—flag (Yes or No) representing the SIP field of the same name
%%User.TooManyItemsOverdue%%—flag (Yes or No) representing the SIP field of the same name
%%User.TooManyRenewals%%—flag (Yes or No) representing the SIP field of the same name
%%User.TooManyClaimsOfItemsRetumed%%—flag (Yes or No) representing the SIP field of the same name
%%User.TooManyItemsLost%%—flag (Yes or No) representing the SIP field of the same name
%%User.ExcessiveOutstandingFines%%—flag (Yes or No) representing the SIP field of the same name
%%User.ExcessiveOutstandingFees%%—flag (Yes or No) representing the SIP field of the same name
%%User.RecallOverdue%%—flag (Yes or No) representing the SIP field of the same name
%%User.TooManyItemsBilled%%—flag (Yes or No) representing the SIP field of the same name
%%User.Language%%—text representing the user's preferred language. The three-letter SIP code is translated into a language name.
%%User.HoldItemsCount%%—number indicating how many items the user has on hold.
%%User.HoldItemsLimit%%—number indicating how many items the user may have on hold.
%%User.HoldItems%%—text listing of all items currently on hold. Items are delimited by “;”. (This item is available as a list variable also.)
%%User.OverdueItemsCount%%—number indicating how many items the user has overdue.
%%User.OverdueItemsLimit%%—number indicating how many items the user may have overdue.
%%User.OverdueItems%%—text listing of all items currently overdue. Items are delimited by “;”. (This item is available as a list variable also.)
%%User.ChargedItemsCount%%—number indicating how many items the user has checked out.
%%User.ChargedItemsLimit%%—number indicating how many items the user may have checked out.
%%User.ChargedItems%%—text listing of all items currently checked out. Items are delimited by “;”. (This item is available as a list variable also.)
%%User.FineItemsCount%%—number indicating how many fine items the user has.
%%User.FineItems%%—text listing of all current fine items. Items are delimited by “;”. (This item is available as a list variable also.)
%%User.RecalItemsCount%%—number indicating how many recall items the user has.
%%User.RecallItems%%—text listing of all current recall items. Items are delimited by “;”. (This item is available as a list variable also.)
%%User.UnavailableHoldsCount%%—number indicating how many unavailable holds the user has.
%%User.UnavailableHolds%%—text listing of all current unavailable holds. Items are delimited by “;”. (This item is available as a list variable also.)
%%User.Id%%—text representing the user's library card number
%%User.FullName%%—text representing the user's name (as returned through SIP)
%%User.IsValid%%—flag (Yes or No) indicating whether the user is valid (as reported through SIP)
%%User.IsValidPassword%%—flag (Yes or No) indicating whether the user's pin is valid (as reported through SIP)
%%User.CurrencyType%%—text representing the user's currency type (three letter code as returned through SIP)
%%User.FeeAmount%%—number indicating how much the user owes in fees
%%User.FeeOwed%%—flag (Yes or No) indicating whether the user owes a fee
%%User.FeeLimit%%—number indicating the fee limit for the user
%%User.HomeAddress%%—text representing the user's address (as returned through SIP)
%%User.EmailAddress%%—text representing the user's email address (as returned through SIP)
%%User.HomePhoneNumber%%—text representing the user's phone number (as returned through SIP)
%%User.ScreenMessage%%—text representing the SIP Screen Message (AF) field
%%User.PrintLine%%—text representing the SIP Print Line (AG) field

Item

Notes—the Item variable represents the last item processed by an action. It may be the item retrieved through getItemRecord, the last item checked out with checkout, or the last item checked in with checkin.
%%Item.Id%%—text representing the item's barcode
%%Item.Title%%—text representing the item's title
%%Item.MediaType%%—text representing the item's media type. The code returned through SIP is translated into human-readable text.
%%Item.Properties%%—text representing the item properties (as returned through SIP)
%%Item.DueDate%%—text representing the date the item is due (if checked out). The data is presented in the same format as returned through SIP.
%%Item.FeeType%%—text representing the fee type associated with this item. The code returned through SIP is translated into human-readable text.
%%Item.FeeAmount%%—number representing the amount of the fee associated with this item.
%%Item.CurrencyType%%—text representing the currency type for the fee amount
%%Item.PermanentLocation%%—text representing the item's permanent location (as returned through SIP)
%%Item.CurrentLocation%%—text representing the item's current location (as returned through SIP)
%%Item.Owner%%—text representing the item's owner (as returned through SIP)
%%Item.HoldQueueLength%%—number indicating the number of patrons requesting this item
%%Item.TransactionDate%%—text representing the timestamp of the SIP message that retrieved this item record. The SIP date is converted into a more readable format.
%%Item.RecalledDate%%—text representing the date the recall was issued (as returned through SIP). The SIP date is converted into a more readable format.
%%Item.HoldPickupDate%%—text representing the date the current hold expires. The SIP date is converted into a more readable format.
%%Item.ScreenMessage%%—text representing the SIP Screen Message (AF) field associated with this item.
%%Item.PrintLine%%—text representing the SIP Print Line (AG) field associated with this item.

Checkout

Notes—these variables are used in the context of the $$Session.CheckedOutItmes$$ list variable.
%%Checkout.Ok%%—flag (Yes or No) indicating whether the item was successfully checked out.
%%Checkout.RenewalOk%%—flag (Yes or No) indicating whether the item was renewed to the patron rather than being checked out.
%%Checkout.IsMagneticMedia%%—flag (Yes or No) indicating whether the item is magnetic media (as reported through SIP). SIP provides a ‘U’ designation in addition to ‘Y’ and ‘N’. LibraryKiosk treats ‘U’ as ‘N’.
%%Checkout.ShouldDesensitize%%—flag (Yes or No) indicating that the item should be desensitized through the inventory security management system.
%%Checkout.TransactionDate%%—text representing the timestamp when the checkout occurred. The SIP date is converted into a more readable format.
%%Checkout.UserId%%—text representing the library card number of the user who checked out the item.
%%Checkout.ItemId%%—text representing the barcode of the item that was checked out.
%%Checkout.ItemTitle%%—text representing the title of the item that was checked out.
%%Checkout.ItemDueDate%%—text representing the due date of the item that was checked out. The date is presented as it is returned through SIP.
%%Checkout.FeeType%%—text representing the type of fee required to checkout this item. The SIP code is translated into human-readable text.
%%Checkout.SecurityInhibit%%—flag (Yes or No) indicating whether LibraryKiosk should ignore the security status of the item.
%%Checkout.CurrencyType%%—text representing the currency type for the fee associated with checking out this item.
%%Checkout.FeeAmount%%—number representing the fee amount associated with checking out this item.
%%Checkout.ItemMediaType%%—text representing the item's media type. The SIP code is translated into human-readable text.
%%Checkout.ItemProperties%%—text representing the item's properties (as returned through SIP).
%%Checkout.FeeTransactionId%%—text representing the transaction id associated with the user's paying the fee for checking out the item.
%%Checkout.ScreenMessage%%—text representing the SIP Screen Message (AF) field for the item checked out.
%%Checkout.PrintLine%%—text representing the SIP Print Line (AG) field for the item checked out.

Checkin

Notes—the variables here are defined in LibraryKiosk but are not exposed at this time. Some information about the checked in item is available through the %%Item.*%% variables.
%%Checkin.Ok%%—flag (Yes or No) indicating whether the checkin was successful.
%%Checkin.IsMagneticMedia%%—flag (Yes or No) indicating whether the item is magnetic media. SIP provides a ‘U’ designation in addition to ‘Y’ and ‘N’. LibraryKiosk treats ‘U’ as ‘N’.
%%Checkin.ShouldResensitize%%—flag (Yes or No) indicating whether the item should be resensitized by the inventory security management system, such as RFID and EM security systems.
%%Checkin.Alert%%—flag (Yes or No) indicating whether checking in this item should generate an audible alert.
%%Checkin.TransactionDate%%—text representing the timestamp for this check in. The SIP date is converted into a more readable format.
%%Checkin.UserId%%—text representing the library card number of the user who had the item checked out.
%%Checkin.ItemId%%—text representing the barcode of the item being checked in.
%%Checkin.ItemTitle%%—text representing the title of the item being checked in.
%%Checkin.ItemMediaType%%—text representing the media type of the item being checked in. The SIP code is translated into human-readable text.
%%Checkin.ItemProperties%%—text representing the item's properties (as returned through SIP).
%%Checkin.ItemPermanentLocation%%—text representing the item's permanent location (as returned through SIP).
%%Checkin.ItemSortBin%%—text representing the item's sort bin (as returned through SIP).
%%Checkin.ScreenMessage%%—text representing the SIP Screen Message (AF) field associated with this item.
%%Checkin.PrintLine%%—text representing the SIP Print Line (AG) field associated with this item.

List Variables

Notes—list variables are used as placeholders in HTML pages for lists of information. The list variable is represented with a syntax that identifies the list variable itself and the format for each item currently held in the list. For example, the following list variable would print each item checked out during the current session as a row in an HTML table.

$$Session.CheckedOutItems{<tr><td>%%Checkout.ItemId%%</td><td>%%Checkout.ItemTitle%%</td><td>%%Checkout.ItemDueDate%%</td></tr>}$$

Session

$$Session.CheckedOutItems{format}$$ —the list of items checked out by the user during this session. Each element in the list is referenced through the %%Checkout.*%% variables.

User

Notes—user list variables are alternative representations for Charged Items, Overdue Items, Hold Items, Fine Items, Recall Items, and Unavailable Holds. Each element in the list is referenced through the special %%User.SummaryItemInformation%% variable.
   $$User.HoldItems{format}$$
   $$User.OverdueItems {format}$$
   $$User.ChargedItems{format}$$
   $$User.FineItems {format}$$
   $$User.RecallItems {format}$$
   $$User.UnavailableHolds {format} $$

Screen Message Cross-Reference Table

LibraryKiosk supports a screen message cross reference table to convert SIP messages from the ILS Server into something that may be more presentable to an end-user. The SIP Screen Message (AF field) and Print Line (AG field) are supported.

The screen message cross-reference table is a file called screenMsgXref.dat located in the Web Server Document Root. If support for multiple languages is enabled, a language-specific version of the file should exist in each language subdirectory.

The file format is plain text key/value pairs, one entry per line. For example: #Please refer this transaction to the service desk=Please see a staff member for assistance.

The value to the left of the equal sign is the text exactly as it is returned from the ILS Server, and the value to the right is the text to be used as a replacement. White space around the equal sign is ignored, as are leading and trailing white spaces on the key and the value. Any entry without an equal sign is ignored.

If the text from the ILS is not found, the original ILS text is used without being converted.

It will thus be appreciated from the above that a customizable user-interaction device can be readily modified without having to re-write executable code.

Any process descriptions, steps, or blocks in the flow or data flow diagrams described herein and/or depicted in the attached figures should be understood as potentially representing modules, segments, or portions of code which include one or more executable instructions for implementing specific logical functions or steps in the process. Alternate implementations are included within the scope of the preferred embodiments of the systems and methods described herein in which steps or functions may be deleted, executed out of order from that shown or discussed, executed concurrently, substantially concurrently, or sequentially, or in reverse order, depending on the functionality involved.

Conditional language, such as, among others, “can”, “could”, “might”, or “may”, unless specifically stated otherwise, or otherwise understood within the context as used, is generally intended to convey that certain embodiments optionally could include, while some other embodiments do not include, certain features, elements and/or steps. Thus, such conditional language indicates, in general, that those features, elements and/or step are not required for every implementation or embodiment.

Various valuable aspects, benefits, capabilities, embodiments and/or features have been described above which are not available in the prior art. Further, these various aspects, benefits, capabilities, embodiments and/or features may be used independently or in combination, as appropriate to achieve a desired result; it is not necessary to incorporate every aspect, benefit, capability, embodiment and/or feature into a single implementation in order to obtain specific desired aspects, benefits, capabilities, and/or features.

Other variations of these aspects, benefits, capabilities, embodiments and/or features will suggest themselves to those of skill in the field upon examination of the drawings and detailed description and all such variations are included within the scope of the present invention, as defined by the accompanying claims. Therefore, the scope of the present invention is to be determined only by the claims.

We claim:

1. A method for operating a user-interaction device, the method comprising:
initiating a browser program;
intercepting a request from the browser program for a home page;
inspecting a preferences file for browser preference information;
generating a home page for the browser based upon the browser preference information;
providing the generated home page to the browser; and
displaying the generated home page to the user via the browser.

2. The method of claim 1 wherein displaying the generated home page to the user comprises displaying to a user at least two options.

3. The method of claim 1 wherein displaying the generated home page to the user comprises displaying to a user at least two options and a name.

4. The method of claim 1 wherein displaying the generated home page to the user comprises displaying to a user at least two of the following options: scan in a user ID card, type in a user name, type in a user name and password, check a user account balance, browse through information available from the user-interactive device, browse through publications available through an entity sponsoring the user-interactive device, check out a selected publication from an entity sponsoring the user-interactive device, or make a payment to a user account.

5. The method of claim 1 and further comprising:
accepting at least one of a user ID card or a user name;
identifying a characteristic of the user based upon at least one of a user ID card or a user name;
generating a user home page based upon the identified characteristic of the user;
providing the generated user home page to the browser; and
displaying the generated user home page to the user via the browser.

6. The method of claim 5 wherein identifying a characteristic of the user comprises determining at least one of: the name of the user, the age of the user, the age group of the user, the account payment status of the user, or the preferences of the user for a user home page.

7. The method of claim 1 wherein generating a home page for the browser based upon the browser preference information comprises inserting predetermined information from the browser preference information into predetermined locations on a predetermined standard web page.

8. A user-interactive device, comprising:
a user input device to allow a user to enter information;
a display device to display information to a user;
a memory, the memory containing a logic program, a browser program, and a preferences file;
a processor functionally connected to the user input device, the display device, and the memory, and configured to execute the at least one logic program and the browser program, to intercept a request from the browser program for a home page, to inspect a preferences file for browser preference information, to generate a home page for the browser based upon the browser preference information, and to cause the browser program to display the generated home page to the user.

9. The user-interactive device of claim 8, wherein the user input device comprises at least one of a keyboard, a mouse, a card scanner, or a touch-sensitive display device.

10. The user-interactive device of claim 8, wherein the display device comprises a display screen.

11. The user-interactive device of claim 8, wherein the display device comprises a touch-sensitive display screen.

12. The user-interactive device of claim 8 and further comprising an interface and a network connection, whereby said processor is functionally connected to an external server to obtain data on preferences.
